(19) United States
(12) Patent Application Publication
(10) Pub. No.: US 2017/0349754 A1
(43) Pub. Date: Dec. 7, 2017

(54) UNIVERSAL METHOD FOR FUNCTIONALIZATION OF DYED MICROSPHERES

(71) Applicant: THE UNITED STATES GOVERMENT AS REPRESENTED BY THE SECRETARY OF THE ARMY-U.S. ARMY RESEARCH LABORATOR, ADELPHI, MD (US)

(72) Inventor: MATTHEW BRADFORD COPPOCK, ARLINGTON, VA (US)

(73) Assignee: THE UNITED STATES GOVERNMENT AS REPRESENTED BY THE SECRETARY OF THE ARM Y, WASHINGTON, DC (US)

(21) Appl. No.: 15/173,753

(22) Filed: Jun. 6, 2016

(51) Int. Cl. C09B 62/00

(52) U.S. Cl. CPC C09B 62/00

(57) ABSTRACT

Provided are processes of functionalizing a microparticle that include reacting a microparticle expressing a carboxylic acid with a functionalization linker including the structure N-L¹-A where N is a free amine, L¹ is a linker, and A is an azide and an alkyne terminated group, to form a functional group terminated microparticle, and forming a functionalized microparticle by reacting the functional group terminated microparticle with a peptide including a terminal functional group comprising an alkyne or azide, where the peptide includes the structure F-L²-Peptide, where F is a functional group and L² is a linker. Also provided are compositions suitable for effectively coupling a peptide to a microsphere and functionalized microspheres suitable for reacting with a detection agent.

### GOVERNMENT INTEREST

The invention described herein may be manufactured, used, and licensed by or for the United States Government.

### FIELD

The present invention relates generally to the field of materials for the assay of biomolecules. Provided are materials such as beads that are functionalized using particular chemistry to provide a robust, uniform, and field usable system for the detection or analysis of biomolecules.

### BACKGROUND

The need for the functionalization of dyed microspheres with peptides is apparent with the ever growing capabilities of peptide reagents and the increased utilization of dyed microspheres in multiplex detection assays. Typically, biomolecules are bound to microsphere surfaces through coupling chemistry that occurs between a carboxylic acid on the particle surface and a primary amine on the biomolecule. Unfortunately, peptides that contain lysine in their sequence are capable of participating in coupling reactions, and could result in an inactive peptide on the particle surface. “Click” chemistry is one method used to functionalize biomolecules at specific locations (Lahann, J., “Click Chemistry: A Universal Ligation Strategy for Biotechnology and Materials Science,” Click Chemistry for Biotechnology and Materials Science, Chapter 1, John Wiley & Sons, Ltd, 2009) and prevent any cross reactions with the free amine in lysine amino acids. Universal microsphere functionalization with “click” chemistry requires complete solubilization of the microspheres and peptides during the reaction. Solubilization can pose a challenge, however, since some peptides require organic solvents to dissolve completely, depending on the length and sequence, and dyed microspheres are prone to dye leaching in organic solvents (U.S. Pat. No. 6,528,165).

Methods have been developed for the functionalization of various particles via “click” chemistry, such as gold nanoparticles (Fleming, D. A.; Thode, C. J.; Williams, M. E., Chemistry of Materials, 18 (9), 2327-2334) and latex microspheres (Breed, D. R.; Thibault, R.; Xie, F.; Wang, Q.; Hawker, C. J.; Pine, D. J., Langmuir, 25(8), 4370-4376), but these methods are limited to the reactions being performed in strictly an organic solvent or water respectively. Also reaction times, on the order of days, (von Maltzahn, G, et al., Bioconjugate Chemistry, 19 (8), 1570-1578), are also a concern for a mixed solvent system due to dye leaching. While there have been improvements in reaction times, harsh microwave conditions must typically be employed for successful functionalization.

As such, new methods of functionalizing particles are needed.

### SUMMARY

The following summary is provided to facilitate an understanding of some of the innovative features unique to the disclosure and is not intended to be a full description. A full appreciation of the various aspects can be gained by taking the entire specification, claims, drawings, and abstract as a whole.

There is a need for improved processes of functionalizing microspheres for use as detection agents in often harsh field conditions. As such, a first object is to provide such processes that allow for robust functionalization of microspheres such as dyed microspheres that allow for high yields in a short time so that leaching of dye or other degradation of agent in or on a microsphere is minimized. A process includes reacting a microparticle expressing a carboxylic acid with a functionalization linker including the structure N-L¹-A where N is a free amine, L¹ is a linker, and A is an azide and an alkyne terminated group, to form a functional group terminated microparticle, and forming a functionalized microparticle by reacting the functional group terminated microparticle with a peptide including an N- or C-terminal functional group comprising an alkyne or azide, where the peptide includes the structure F-L²-Peptide, where F is a functional group and L² is a linker. In some aspects, L¹, L², or both include oxyethylene. Oxyethylene moieties are optionally of 3 or more, optionally 10 or more, either both or independently. Optionally, L1 includes from 6 to 200 oxyethylene moieties, optionally 10 to 20 moieties of oxyethylene. The provided processes have the capability of rapid use where in some aspects, the step of reacting the azide terminated microparticle proceeds for a reaction time of 2 hours or less, optionally 1 hour or less. Optionally, the step of forming includes reacting the azide terminated microparticle with said peptide in an organic solvent including dimethyl sulfoxide, optionally 5% to 5% by volume DMSO. In some aspects, a functionalization linker consists of the formula

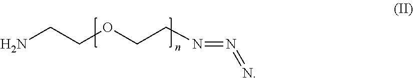

Optionally, a peptide includes the formula of

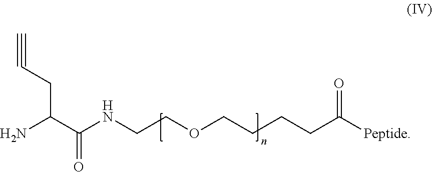

The peptide optionally includes 2 to 100 amino acids. In some aspects, a microparticle includes a dye.

Another object is to provide a composition for analysis of a biomolecule, optionally under field conditions, where the composition includes

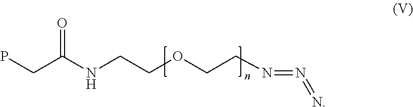

where P represents a microparticle and n is from 1 to 200. In some aspects, the composition further includes a peptide including 2 to 100 amino acids. Optionally, the peptides is covalently linked to the composition by an azide-alkyne cycloaddition. The microsphere (P) optionally includes a dye, optionally a fluorescent dye.

### BRIEF DESCRIPTION OF THE DRAWINGS

FIG. 1 illustrates a scheme of forming a functionalized microparticle according to one aspect;

FIG. 2 illustrates the concentration dependent effect of the addition of from 5% to 50% by weight DMSO to the reaction linking an azide terminated microparticle with a peptide expressing an N-terminal functional group and the MIF reflects the concentration of the dye in the beads;

FIG. 3 illustrates the effect of linker length off the microparticle surface from PEG6 to PEG 169 on the magnitude of the resulting signal; and

FIG. 4 illustrates the successful coupling of short, hydrophobic biotinylated peptides to the surface of the microspheres.

### DETAILED DESCRIPTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, parameters and/or sections, these elements, components, regions, layers, parameters, and/or sections should not be limited by these terms. These terms are only used to distinguish one element, component, region, layer, parameter, or section from another element, component, region, layer, parameter, or section. Thus, “a first element,” “component,” “region,” “layer,” “parameter,” or “section” discussed below could be termed a second (or other) element, component, region, layer, parameter, or section without departing from the teachings herein.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Provided are processes for functionalizing assay reagents such as microparticles utilizing a mixed organic/water solvent system while significantly reducing the reaction time, optionally keeping the reaction time to 1 hour, in order to significantly reduce label leaching from the microspheres. Cutting the reaction time to 1 hour increases the sensitivity of the assay from about 20 to about 25 percent (%) using (MFI 1 hour-MFI 24 hour)/MFI 1 hour. The provided processes enable researchers to attach any detection reagent (e.g. peptide) to a labeled (e.g. dyed) microparticle (a process known as “functionalization”), regardless of peptide length and sequence. Once produced, these functionalized microparticles can be used as bio-recognition elements for sensing and diagnostics via fluorescence-based multiplex assay platforms.

A process as provided capitalizes on a process known as “click” chemistry to attach a detection agent such as a peptide to an assay reagent such as a microparticle. The processes are able to dramatically improve the functional detection agent linked with the microparticle to improve function in binding to and/or detecting an agent in a sample. The processes eliminate unwanted side reactions with primary amines that have historically resulted in less than optimal results. In addition, the processes are capable of rapid binding so as to significantly reduce the amount of dye leaching or other dye degradation from a microparticle also boosting downstream function.

A process includes reacting a microparticle expressing a carboxyl group with a functionalization linker comprising N-L¹-A where N is a free amine, L¹ is a linker, and A is an azide or an alkyne terminated group (e.g. C₃-C₁₀₀ linear or branched alkyne), to form an functional group terminated microparticle; and forming a functionalized microparticle by reacting said functional group terminated microparticle with a peptide comprising an N-terminal functional group expressing a terminal alkyne or azide such that the peptide has a structure F-L²-Peptide where F is a functional group and L² is a linker. The alkyne or azide on the functional group terminated microparticle is complementary to the alkyne or azide on the peptide such that a reaction between an azide and an alkyne is utilized in the formation of the functionalized microparticle. Optionally, the functional group on the functional group terminated microparticle is an azide and the functional group F on the peptide is an alkyne. Optionally, the functional group on the functional group terminated microparticle is an alkyne and the functional group F on the peptide is an azide.

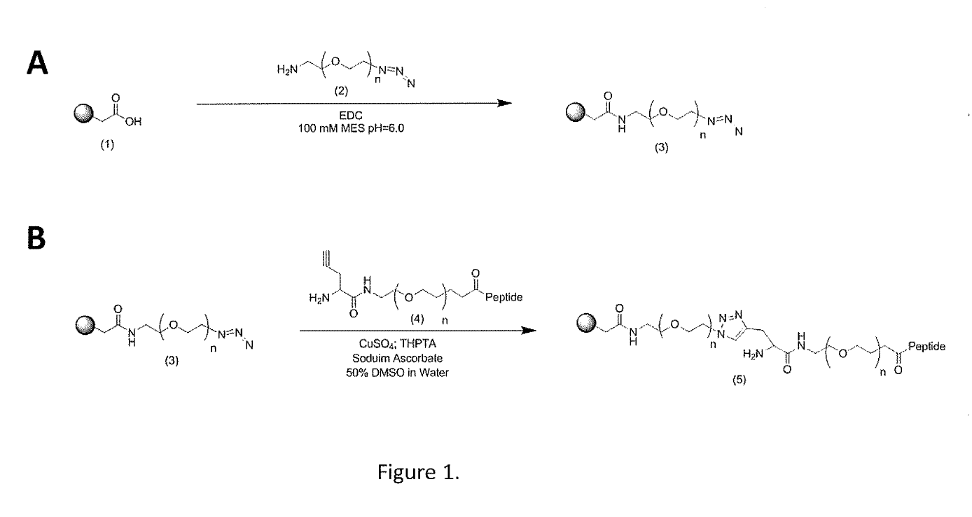

An illustrative process according to one aspect can be found in FIG. 1A. In FIG. 1A, composition (1) represents an unlabeled microparticle (sphere), otherwise herein denoted as P, where the microparticle expresses a carboxyl group on a surface that is accessible by a functionalization linker. Such a functionalization linker illustratively presented as (2) includes a free amine and an azide. A functionalization linker is reacted with the microparticle in the presence of 1-ethyl-3-(3-dimethylaminopropyl)carbodiimide (EDC) in 100 mM MES buffer. The reaction is allowed to proceed to completion to produce the azide terminated microparticle illustrated at (3).

In a second step illustrated in one aspect at FIG. 1B, an azide terminated microparticle is reacted with a detection agent, illustratively a peptide, where detection agent is tagged with an alkyne expressing moiety such that an azide-alkyne cycloaddition to the azide terminated microparticle is possible. While several methods of azide-alkyne cycloadditions are possible (e.g. Huisgen 1,3-Dipolar Cycloaddition, Copper-Catalyzed Azide-Alkyne Cycloaddition, Ruthenium-Catalyzed Azide-Alkyne Cycloaddition), the use of copper as a catalyst results in the specific synthesis of the 1,4-disubstituted regioisomers and avoids the mixtures of regioisomers that results from the Huisgen 1,3-Dipolar Cycloaddition. In the exemplary synthesis of FIG. 1B, the alkyne-PEG-Peptide is reacted with the functionalized microparticle in the presence of CuSO₄ catalyst, 50% DMSO in deionized water, tris-(benzyltriazolylmethyl)amine (TBTA), and sodium ascorbate. The reaction is substantially complete in less than 1 hour to form a fully functionalized microparticle.

The processes have the ability to use any commercially available or custom synthesized microparticles that include a carboxylic acid, or other suitable active group, to allow proper functionalization by reaction with an azide containing linker. A microparticle is optionally any microparticle described in U.S. Pat. No. 5,981,180. Microparticles are generally known in the art and may be obtained from manufacturers such as Luminex, BioRad, Spherotech, Molecular Probes, and Polysciences, Inc. One illustrative example of a dyed microparticle is POLYBEAD dyed microparticle available from Polysciences, Inc. A microparticle has a diameter or other linear maximal dimension that is optionally 500 μm or less, optionally 100 μm, or less, optionally 1 μm or less.

A microparticle optionally includes a dye, optionally in the form of a chromophore, fluorophore, lumiphore, radioisotope, magnetic element, or other optical or physical property imparting component. Dyes are recognized in the art and impart a variety of colors. Illustrative examples of dyed carboxylate microparticles are the POLYBEAD carboxylate dyed beads or PROMAG superparamagnetic beads each available from Polysciences, Inc., Warrington, Pa. Among the numerous available fluors or fluorophores described in the art suitable for use as a dye, phycocyanines (for example, phycoerythrin, allophycocyanin) and cyanines, including the CY™ dyes, are particular illustrative examples.

A microparticle is formed of any material that may be functionalized with a carboxyl reactive group on the surface. Illustrative examples include polymers such as polystyrene, or other materials such as silica. Polymers may be homopolymers or copolymers including two or more monomers. Copolymers may have a sequence that is random, block, or include a combination of random and block sequences. Polymers are optionally organic polymers.

Examples of polymers include, but are not limited to, polyethylenes, polycarbonates (e.g. poly(1,3-dioxan-2one)), polyanhydrides (e.g. poly(sebacic anhydride)), polypropylfumerates, polyamides (e.g. polycaprolactam), polyacetals, polyethers, polyesters (e.g., polylactide, polyglycolide, polylactide-co-glycolide, polycaprolactone, polyhydroxyacid (e.g. poly(β-hydroxyalkanoate))), poly(orthoesters), polycyanoacrylates, polyvinyl alcohols, polyurethanes, polyphosphazenes, polyacrylates, polymethacrylates, polyureas, polystyrenes, and polyamines, polylysine, polylysine-PEG copolymers, and poly(ethyleneimine), poly(ethylene imine)-PEG copolymers.

In some aspects, polymers are approved for use in humans by the U.S. Food and Drug Administration (FDA) under 21 C.F.R. §177.2600, including but not limited to: polyesters (e.g., polylactic acid, poly(lactic-co-glycolic acid), polycaprolactone, polyvalerolactone, poly(1,3-dioxan-2one)); polyanhydrides (e.g., poly(sebacic anhydride)); polyethers (e.g., polyethylene glycol); polyurethanes; polymethacrylates; polyacrylates; and polycyanoacrylates. Suitable polymeric microparticle formation methods are illustratively found in U.S. 2012/0058154.

Bare microparticles of various sizes ranges also bearing one or more fluorescent dyes or the same dye at different levels are available from several vendors including Luminex, BioRad, Bangs Labs, Interfacial Dynamics, Molecular Probes, Polysciences, CPG. Incorporation of suitable dyes can be done by direct coating to achieve relatively weak surface labeling with different fluors as taught in the art, or optionally, by adding the dye or dye mixtures during the emulsion polymerization process in the preparation of the optically labeled microparticles bearing a single or mixed optical labels at varying ratios as disclosed in U.S. Pat. No. 5,795,719. Processes for preparing magnetic polymeric latex particles are also known in the art (e.g. U.S. Pat. No. 4,358,388).

In a process as provided herein, a microparticle is reacted with a functionalization linker to form an azide or alkyne terminated microparticle. A functionalization linker serves to associate a reactive azide or alkyne group with a microparticle for subsequent functionalization with a detection agent (e.g. peptide). A functionalization linker includes a structure of formula I.

N-L¹-A (I)

where N is a free amine, L¹ is a linker, and A is an azide or alkyne. The amine serves to associate with the carboxyl group of the microparticle to form an amide linkage. The linker L¹ is optionally an alkyl, alkenyl, alkynyl, oxyethylene, or other suitable linear or branched molecule. In some aspects, a linker L¹ excludes a carbodiimide group. In some aspects, a functionalization linker excludes a carbodiimide group. In some aspects, the free amine is associated with a linker L1 by a C₁ to C₁₀ linear or branched alkyl, alkenyl, alkynyl, or other suitable group.

A functionalization linker optionally includes a structure of formula II

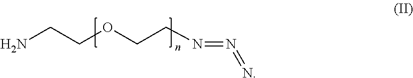

where n is any value from 1 to 200 or more. In some aspects, n is 5 to 200, optionally 100 to 200, optionally 150 to 200. Optionally, n is greater than 5, greater than 6, greater than 10, or greater than 100. In some aspects, n does not exceed 200. Optionally, n is 10, 11, 12, 13, 14, 15, 16, 17, 18, 19, or 20.

A process also includes forming a functionalized microparticle by reacting the azide or alkyne terminated microparticle with a detection agent including an N-terminal functional group such as an alkyne or azide terminated structure. The alkyne or azide terminated structure will react with the complementary azide or alkyne on the terminus of the microparticle to link the detection agent to the microparticle to form the fully functionalized microparticle.

A detection agent includes a molecule suitable for reacting with or binding to an analyte in a sample. A detection agent optionally includes a peptide, antibody, nucleic acid, or other suitable agent. In some aspects, a detection agent includes a peptide. A peptide optionally includes from 2 to 100 amino acids, optionally 5-50 amino acids, linked by peptide bonds to form a sequence. The terms “peptide,” “polypeptide,” and “protein” are synonymous as used herein and are intended to mean a natural or synthetic compound containing two or more amino acids. Amino acids present in a peptide include the common amino acids alanine, cysteine, aspartic acid, glutamic acid, phenylalanine, glycine, histidine, isoleucine, lysine, leucine, methionine, asparagine, proline, glutamine, arginine, serine, threonine, valine, tryptophan, and tyrosine as well as less common naturally occurring amino acids, modified amino acids or synthetic compounds, such as alpha-asparagine, 2-aminobutanoic acid or 2-aminobutyric acid, 4-aminobutyric acid, 2-aminocapric acid (2-aminodecanoic acid), 6-aminocaproic acid, alpha-glutamine, 2-aminoheptanoic acid, 6-aminohexanoic acid, alpha-aminoisobutyric acid (2-aminoalanine), 3-aminoisobutyric acid, beta-alanine, allo-hydroxylysine, allo-isoleucine, 4-amino-7-methylheptanoic acid, 4-amino-5-phenylpentanoic acid, 2-aminopimelic acid, gamma-amino-beta-hydroxybenzenepentanoic acid, 2-aminosuberic acid, 2-carboxyazetidine, beta-alanine, beta-aspartic acid, biphenylalanine, 3,6-diaminohexanoic acid, butanoic acid, cyclobutyl alanine, cyclohexylalanine, cyclohexylglycine, N5 -aminocarbonylornithine, cyclopentyl alanine, cyclopropyl alanine, 3-sulfoalanine, 2,4-diaminobutanoic acid, diaminopropionic acid, 2,4-diaminobutyric acid, diphenyl alanine, N,N-dimethylglycine, diaminopimelic acid, 2,3-diaminopropanoic acid, S-ethylthiocysteine, N-ethylasparagine, N-ethylglycine, 4-aza-phenylalanine, 4-fluoro-phenylalanine, gamma-glutamic acid, gamma-carboxyglutamic acid, hydroxyacetic acid, pyroglutamic acid, homoarginine, homocysteic acid, homocysteine, homohistidine, 2-hydroxyisovaleric acid, homophenylalanine, homoleucine, homoproline, homoserine, homoserine, 2-hydroxypentanoic acid, 5-hydroxylysine, 4-hydroxyproline, 2-carboxyoctahydroindole, 3-carboxyisoquinoline, isovaline, 2-hydroxypropanoic acid (lactic acid), mercaptoacetic acid, mercaptobutanoic acid, sarcosine, 4-methyl-3-hydroxyproline, mercaptopropanoic acid, norleucine, nipecotic acid, nortyrosine, norvaline, omega-amino acid, ornithine, penicillamine (3-mercaptovaline), 2-phenylglycine, 2-carboxypiperidine, sarcosine (N-methylglycine), 2-amino-3 -(4-sulfophenyl)propionic acid, 1-amino-1-carboxycyclopentane, 3-thienylalanine, epsilon-N-trimethyllysine, 3 -thiazolylalanine, thiazolidine 4-carboxylic acid, alpha-amino-2,4-dioxopyrimidinepropanoic acid, and 2-naphthylalanine.

A peptide is obtained by any of various methods known in the art illustratively including isolation from a cell or organism, chemical synthesis, expression of a nucleic acid and partial hydrolysis of proteins. Chemical methods of peptide synthesis are known in the art and include solid phase peptide synthesis and solution phase peptide synthesis for instance. In some aspects, chemical methods of peptide synthesis are preferred and are achieved by iteratively adding amino acids in a C- to N-terminal direction beginning from the N-terminus of the peptides as to allow the alkyne-L²-structure to serve as the amino terminal end of the peptide. Optionally, the alkyne-L² structure is added to a peptide following synthesis.

In some aspects, a detection agent includes a structure with formula III

F-L²-Peptide (III)

Where F is a functional group including an alkyne or azide, L² is an optional linker optionally including a C₁-C₂₀₀₀ alkyl, alkenyl, or alkynyl, oxyethylene, or other suitable linear or branched molecule. In some aspects, a linker L² includes a polyoxyethylene structure with 1 to 200 moieties of oxyethylene. The linker L² is optionally covalently bound to the N-terminus or the C-terminus of the peptide.

In some aspects a detection agent includes a structure of formula IV.

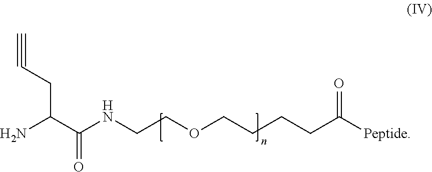

where n is any value from 1 to 200 or more. In some aspects, n is 5 to 200, optionally 100 to 200.

The detection agent is optionally linked to the azide or alkyne terminated microparticle by a covalent interaction. Optionally, a detection agent can be covalently coupled to the external surface of the functional group terminated microparticle via a 1,2,3-triazole linker formed by the 1,3-dipolar cycloaddition reaction of azido groups on the surface microparticle or detection agent terminus with peptides microparticles containing an alkyne group. Such cycloaddition reactions are preferably performed in the presence of a Cu(I) containing catalyst along with a suitable Cu(I)-ligand and a reducing agent to reduce Cu(II) compound to catalytic active Cu(I) compound. This Cu(I)-catalyzed azide-alkyne cycloaddition (CuAAC) can also be referred as the click reaction. The 1,3-dipolar cycloaddition reaction is performed with or without a catalyst, optionally with Cu(I)-catalyst, which links the two components through a 1,2,3-triazole function. This chemistry is described in detail by Sharpless et al., Angew. Chem. Int. Ed. 41(14), 2596, (2002) and Meldal, et al, Chem. Rev., 2008, 108(8), 2952-3015.

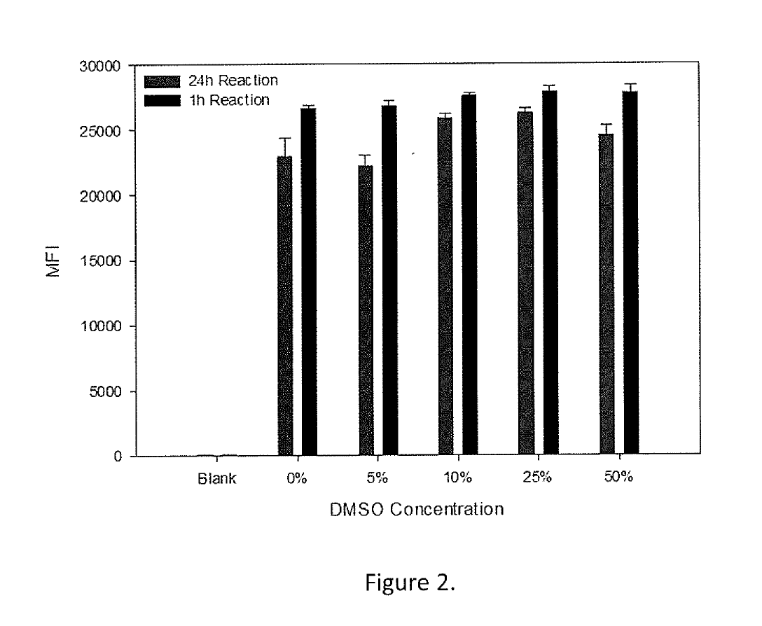

One aspect of the processes provided is that the linkage of the detection agent to the microparticle may take place in a reaction with a reaction time of 2 hours or less, optionally 1 hour or less. Such short reaction times provide a scheme whereby leeching of the dye within or bound to the microparticle is minimized thereby improving subsequent detection reactions. FIG. 2 indicates the effect on the produced signal due to the concentration of DMSO during the bead functionalization at 1 hour and 24 hours. Cutting the reaction time to 1 hour increases the sensitivity of the assay 20 to 25 percent.

In some aspects, a reaction time is from 10 minutes to 2 hours, optionally 30 minutes to 60 minutes. A reaction linking the detection agent to the microparticle is optionally performed at ambient temperatures and pressures (e.g. 25° C., 1 atm). A reaction is optionally performed at pH 7.0.

The linkage of the detection agent to the functional group terminated microparticle is performed in a reaction solvent. A reaction solvent is optionally aqueous or non-aqueous. In some aspects, a reaction solvent includes an organic solvent such as dimethyl sulfoxide (DMSO). DMSO is optionally present in a reaction solvent at a concentration of 5% by volume or greater, optionally 10% by volume or greater, optionally 25% by volume or greater, optionally 50% by volume or greater. DMSO is optionally present at a concentration of 5% to 50% by volume or any value or range therebetween. It was unexpectedly found that at DMSO a concentration of 25% by volume to 50% by volume or greater resulted in superior product with a higher signal relative to a functionalized microparticle produced using a reaction solvent at lower concentrations of DMSO. As such, some aspects include from 25% to 50% by volume DMSO.

Also provided are compositions suitable for the analysis of a biomolecule where the composition includes the structure of formula V

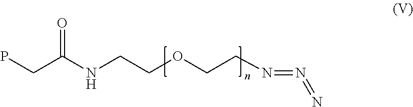

where P represents a microparticle and n is from 1 to 200. In some aspects, n is 6 to 100, optionally 100 to 200, optionally 15 to 20. Optionally, n is greater than 5, greater than 6, greater than 10, or greater than 100. In some aspects, n does not exceed 100. Optionally, n is 10, 11, 12, 13, 14, 15, 16, 17, 18, 19, or 20.

An azide terminated microparticle as provided herein can be synthesized using any microparticle substantially as described herein with the proviso that the microparticle express a carboxyl group on the surface accessible by a functionalization intermediate also as described herein.

Also provided is a composition suitable for analyzing a sample wherein the composition of Formula V further includes a peptide covalently bound thereto either directly or through an intermediate linker. A peptide is any peptide as described herein, optionally including any number of amino acids from 2 to 100. A peptide is covalently associated to the composition of Formula V via an azide-alkyne cycloaddition to yield a triazole linkage between the peptide and the composition.

Various aspects of the present invention are illustrated by the following non-limiting examples. The examples are for illustrative purposes and are not a limitation on any practice of the present invention.

### EXAMPLES

### Example 1

### Coupling of Amine-PEGₙ-Azide Linker to Microspheres

80 μL of dyed microspheres (xMap microspheres from Luminex; 12.5 million beads/mL; 6.5 μm in diameter) were washed 1× with 250 μL water and 1× with 250 μL 0.1 M MES (2-(N-morpholino)ethanesulfonic acid) pH=6.0, then resuspended in 80 μL 0.1 MES pH=6.0. The microspheres were combined with 1 mL 0.12 mg/mL amine-PEGₙazide (where n was 6, 10, 17, 34, 58 or 169) and 200 μL 0.8 mg/mL EDC (1-ethyl-3-(3-dimethylaminopropyl)carbodiimide) solution. The mixture was rotated for 2 hours in the dark at room temperature. The reaction was washed 2× with 250 μL water and resuspended in 80 μL water.

### Example 2

### Addition of Peptides to Microspheres via “Click” Reaction

8 μL of linker modified microspheres (12.5 million beads/mL) from Example 1, 149.5 μL of 0%, 5%, 10%, 25%, or 50% (by volume) DMSO in water, 10 μL 750 μM Alkyne-PEGₙ-Peptide where the alkyne is a C₂ to C₅ alkyne and n is 6, 10, 17, 34, 58, or 169 (e.g. either alkyne-PEG₁₇-AFHFY-Biotin, or alkyne-PEG₁₇-WNQVW-Biotin) in DMSO, 7.5 μL of 1:2 20 mM CuSO₄:50 mM THPTA (tris(3-hydroxypropyltriazolylmethyl)amine) in water, and 25 μL 100 mM sodium ascorbate in water were combined and rotated for 1 hour at room temperature in the dark. The reaction was washed 2× with 500 μL 5% w/v sodium diethylthiocarbamate for 8 min at room temperature in the dark, followed by 2× with 250 μL water. The microspheres were incubated with 250 μL PBS-TBN (phosphate buffered saline, 0.1% bovine serum albumin, 0.02% Tween-20, 0.05% sodium azide) for 30 min at room temperature in the dark. The microspheres were washed 2× with 250 μL PBS-TBN and resuspended in 200 μL PBS-TBN.

### Example 3

### Assay of Peptide Functionalized Dyed Microspheres

The resulting functionalized microspheres of Example 2 were analyzed using a Luminex 200 instrument (Luminex Corp., Austin, Tex.) following procedures in the xMap Cookbook 2^{nd} Ed provided by Luminex. As illustrated in FIG. 2, the amount of DMSO affects the resulting functionality of the peptide bound beads with the greatest signal achieved at a concentration of 50% by volume DMSO used as a reactant. In addition, while a 24 hour reaction was functional, improved results were achieved with a shorter reaction time of 1 hour possible using the claimed linkers and functionalized peptides as the shorter reaction time reduces leaching of dye from the beads to the system.

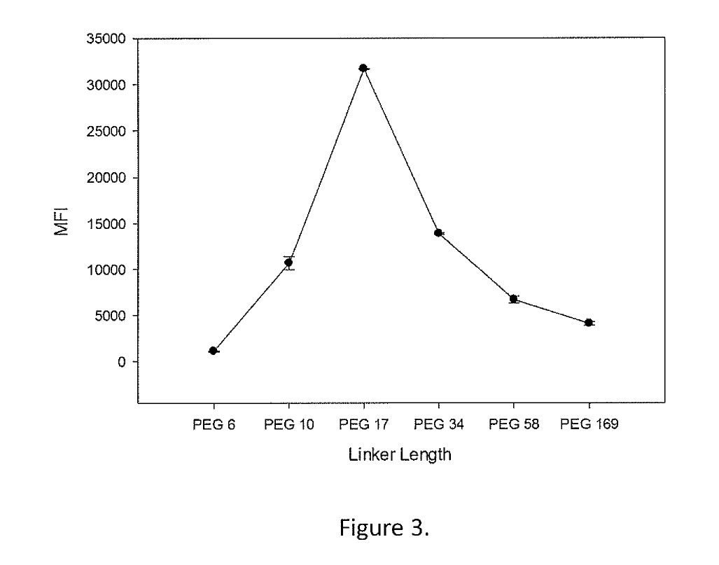

As illustrated in FIG. 3, the length of the PEG linker affects the resulting detectability of the final reagent. While a PEG with 6 ethylene glycol moieties produced relatively low signal, the signal was dramatically improved with linker lengths between 10 and 34 with a peak linker length of 17 ethylene glycol moieties.

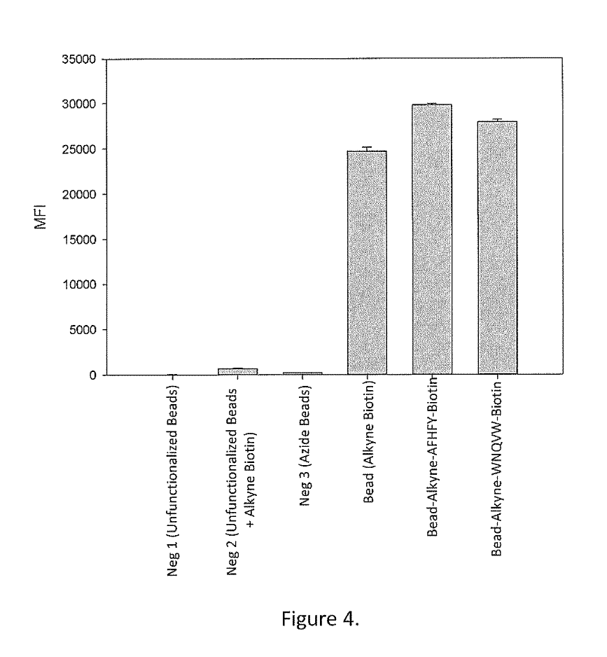

As illustrated in FIG. 4, upon binding the dyed microspheres, hydrophobic and water insoluble peptides are capable or reactions and being detected in water as the presence of the microsphere provides a suitable environment for use in water.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof. The following claims, including all equivalents thereof, are intended to define the scope of the invention.

We claim:

1. A process of functionalizing a microparticle comprising:
reacting a microparticle expressing a carboxylic acid with a functionalization linker comprising N-L1-A where N is a free amine, L1 is a linker, and A is an azide or an alkyne terminated group, to form a functional group terminated microparticle;
forming a functionalized microparticle by reacting said functional group terminated microparticle with a peptide comprising an N- or C-terminal functional group comprising an alkyne or azide, said peptide comprising the structure F-L2-Peptide, where F is a functional group and L2 is a linker; and
further wherein said microparticle is a dye.

2. The process of claim 1 wherein L1, L2, or both comprise oxyethylene.

3. The process of claim 1 wherein L1 comprises an oxyethylene with greater than ten (10) oxyethylene moieties.

4. The process of claim 1 wherein said step of reacting said azide terminated microparticle proceeds for a reaction time of 2 hours or less.

5. The process of claim 4 wherein said reaction time is 1 hour or less.

6. The process of claim 1 wherein said step of forming comprises reacting said azide terminated microparticle with said peptide in an organic solvent comprising dimethyl sulfoxide.

7. The process of claim 6 wherein said dimethyl sulfoxide is at a concentration between 5 percent and 50 percent by volume.

8. The process of claim 1 wherein said L1 comprises a polyoxyethylene with 6 to 200 oxyethylene moieties.

9. The process of claim 1 wherein said functionalization linker consists of

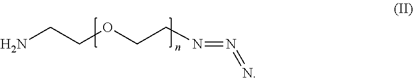

10. The process of claim 1 wherein said peptide comprises

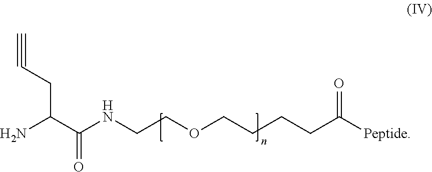

11. (canceled)

12. The process of claim 1 wherein said peptide comprises 2 to 100 amino acids.

13. A composition for analysis of a biomolecule comprising: 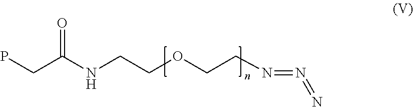
where P represents a microparticle and n is from 1 to 200.

14. The composition of claim 13 further comprising a peptide comprising 2 to 100 amino acids.

15. The composition of claim 14 wherein said peptide is covalently linked to said composition by an azide-alkyne cycloaddition.

16. The composition of claim 13 wherein P comprises a dye.

17. The composition of claim 16 wherein said dye is a fluorescent dye.
